(19) United States
(12) Patent Application Publication
(10) Pub. No.: US 2025/0109221 A1
(43) Pub. Date: Apr. 3, 2025

(54) CROSS-LINKED HYDROPHOBIC COATING WITH PLASMA RESISTANCE FOR DIE-TO-WAFER SELF-ALIGNMENT ASSISTED ASSEMBLY

(71) Applicant: Intel Corporation, Santa Clara, CA (US)

(72) Inventors: Wenhao Li, Chandler, AZ (US); Veronica Strong, Hillsboro, OR (US); Feras Eid, Chandler, AZ (US); Bhaskar Jyoti Krishnatreya, Hillsboro, OR (US)

(73) Assignee: Intel Corporation, Santa Clara, CA (US)

(21) Appl. No.: 18/374,530

(22) Filed: Sep. 28, 2023

(51) Int. Cl. C08F 20/18; C08F 22/10; C09J 133/10

(52) U.S. Cl. CPC C08F 20/18; C08F 22/1006; C09J 133/10

(57) ABSTRACT

Hybrid bonded die stacks, related apparatuses, systems, and methods of fabrication are disclosed. One or both of an integrated circuit (IC) die hybrid bonding region and a base substrate hybrid bonding region surrounded by hydrophobic structures that include a cross-linked material. The hybrid bonding regions are brought together with a liquid droplet therebetween, and capillary forces cause the IC die to self-align. A hybrid bond is formed by evaporating the droplet and a subsequent anneal. The cross-linked material hydrophobic structures contain the liquid droplet for alignment and are resistant to plasma treatment prior to bonding.

### BACKGROUND

The integrated circuit industry is continually striving to produce ever faster, smaller, and more efficient integrated circuit devices, packages, and systems for use in various electronic products. Current die stacks can be formed using solder to solder bump attachment techniques. For example, on two separate dies, solder bumps may be deposited on copper pillars. The solder bumps may then be brought into contact to join the dies, and underfill material may be formed between the solder bonds and copper pillars. Such processes disadvantageously necessitate a large distance between the bonded dies.

Alternatively, hybrid bonds may be formed between corresponding metallic bond pads on the two dies, with the metallic bond pads interspersed among dielectric material (e.g., an oxide). Prior to bonding, the surface of each die may be controlled to promote bonding by providing a recess of the metallic bond pads relative to the dielectric material, having the dielectric material be planar and relatively smooth, and others. Furthermore, prior to bonding, the hybrid bond regions may be cleaned and activated using plasma processing. The dies, having mirror image bond pads, are then brought together such that corresponding metallic bond pads and corresponding dielectric material surfaces of the two dies interface with one another. At room temperature, the dielectric materials adhere sufficiently to one another (due to Van der Waals forces) to maintain a bond. A high temperature anneal is then performed to bond the corresponding metallic bond pads, and to improve the dielectric material bond. Such processes reduce the distance between the bonded dies, reduce pitches between the metal bonds, and offer other advantages. For example, solder bump techniques may be limited to pitches of about 30 μm while hybrid bonding can attain less than 10 μm and even less than 1 μm pitches.

However, difficulties in forming 3D die stacks using hybrid bonding techniques persist. It is with respect to these and other considerations that the present improvements have been needed. Such improvements may become critical as the desire to provide improved integrated circuit devices, packages, and systems becomes more widespread.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 provides a flow diagram illustrating an example process for fabricating IC structures inclusive of 3D die stacks with hybrid bonding regions within containment features having cross-linked material systems;

FIGS. 2, 3, 4A, 4B, 4C, and 4D are illustrations of cross-sectional side views of integrated circuit (IC) structures having different structural implementations of cross-linked material systems being prepared for self-alignment bonding;

FIG. 4E illustrates a top-down view of the IC structure of FIG. 4D showing bonding regions defined by a hydrophobic pattern;

FIGS. 5, 6, 7, 8, and 9 are illustrations of cross-sectional side views of the fabrication of IC structures having cross-linked material systems using selective UV treatment and lift-off techniques;

FIGS. 10, 11, 12, 13, and 14 are illustrations of cross-sectional side views of the fabrication of IC structures having cross-linked material systems using selective heat treatment and lift-off techniques;

FIGS. 15, 16, and 17 are illustrations of cross-sectional side views of the fabrication of IC structures having cross-linked material systems using self-assembled monolayers that are cross-linked after lift-off exposure of hybrid bonding regions;

FIGS. 18, 19, 20, and 21 are illustrations of cross-sectional side views of hybrid bonding of IC dies to a base substrate;

FIG. 22 is an illustration of a cross-sectional side view of an assembly structure similar to the IC structure of FIG. 21 after packaging and deployment of heat removal solutions;

FIG. 23 illustrates an example microelectronic device assembly including a 3D die stack having a hybrid bond with a cross-linked hydrophobic material around an outer perimeter of the hybrid bond; and

FIG. 24 is a functional block diagram of an electronic computing device, all arranged in accordance with at least some implementations of the present disclosure.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

Reference is made in the following detailed description to the accompanying drawings, which form a part hereof, wherein like numerals may designate like parts throughout to indicate corresponding or analogous elements. It will be appreciated that for simplicity and/or clarity of illustration, elements illustrated in the figures have not necessarily been drawn to scale. For example, the dimensions of some of the elements may be exaggerated relative to other elements for clarity. Further, it is to be understood that other embodiments may be utilized, and structural and/or logical changes may be made without departing from the scope of claimed subject matter. It should also be noted that directions and references, for example, up, down, top, bottom, over, under, and so on, may be used to facilitate the discussion of the drawings and embodiments and are not intended to restrict the application of claimed subject matter. Therefore, the following detailed description is not to be taken in a limiting sense and the scope of claimed subject matter defined by the appended claims and their equivalents.

In the following description, numerous details are set forth. However, it will be apparent to one skilled in the art, that the present invention may be practiced without these specific details. In some instances, well-known methods and devices are shown in block diagram form, rather than in detail, to avoid obscuring the present invention. Reference throughout this specification to “an embodiment” or “one embodiment” means that a particular feature, structure, function, or characteristic described in connection with the embodiment is included in at least one embodiment of the invention. Thus, the appearances of the phrase “in an embodiment” or “in one embodiment” in various places throughout this specification are not necessarily referring to the same embodiment of the invention. Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items.

The terms “coupled” and “connected,” along with their derivatives, may be used herein to describe structural relationships between components. It should be understood that these terms are not intended as synonyms for each other. Rather, in particular embodiments, “connected” may be used to indicate that two or more elements are in direct physical or electrical contact with each other. “Coupled” may be used to indicated that two or more elements are in either direct or indirect (with other intervening elements between them) physical or electrical contact with each other, and/or that the two or more elements co-operate or interact with each other (e.g., as in a cause an effect relationship).

The terms “over,” “under,” “between,” “on”, and/or the like, as used herein refer to a relative position of one material layer or component with respect to other layers or components. For example, one layer disposed over or under another layer may be directly in contact with the other layer or may have one or more intervening layers. Moreover, one layer disposed between two layers may be directly in contact with the two layers or may have one or more intervening layers. In contrast, a first layer “on” a second layer is in direct contact with that second layer. Similarly, unless explicitly stated otherwise, one feature disposed between two features may be in direct contact with the adjacent features or may have one or more intervening features. The term immediately adjacent indicates such features are in direction contact. Furthermore, the terms “substantially,” “close,” “approximately,” “near,” and “about,” generally refer to being within +/−10% of a target value. The term layer as used herein may include a single material or multiple materials. As used in throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C.

Integrated circuit structures, 3D die stack structures, devices, apparatuses, systems, and methods are described herein related to hybrid bonding with the hybrid bonding regions surrounded by cross-linked hydrophobic coatings that are resilient to pre-bonding plasma processing of the hybrid bonding regions.

As described above, hybrid bonding techniques offer advantages in the assembly of 3D die stacks. As used herein, the term multi-level 3D die stack indicates a stack of devices or structures having at least partially vertically aligned layers such that each layer or level of the 3D die stack may employ one or more IC dies each. The term layer or level of a 3D die stack indicates a horizontal portion of the 3D die stack that includes only one depth of device within the horizontal portion (e.g., each layer or level may have any number of IC dies in the horizontal plane). The term multi-level 3D die stack indicates a die stack having multiple levels such as two or more levels over a base substrate. The term IC die includes any monolithic integrated device that provides electrical, compute, memory, or similar functionality. IC dies include chiplets, chiplet dies, memory dies, processor dies, routing dies, and so on. Herein, the terms chiplet and IC die are used interchangeably. An IC die may be passive such that it only includes electrical routing, or it may be active such that it includes electrical devices such as transistors, capacitors, etc. The term base substrate, base wafer, or base die indicates a substrate having active or passive electrical features. In contrast, the term structural substrate, structural wafer, or structural die indicates a substrate absent from any active or passive electrical features. For example, a structural substrate may be a monolithic material such as silicon, or other base material that provides structural support and heat removal.

In the context of hybrid bonding of IC dies, faster throughput may be attained during die-to-wafer hybrid bonding (D2 W HB) using self-alignment assisted assembly (SA3). In SA3 process flows, a liquid droplet is dispensed on the bonding area on either the top chiplet die or the base wafer to be bonded. A bonder is then used to pick and place the chiplet die onto the base wafer at coarse alignment (e.g., ˜ 25-50 μm), such that the water droplet is sandwiched in the bonding area between the chiplet and the base wafer. Capillary forces cause the chiplet to self-align to its desired bonding location on the wafer with high positional accuracy (e.g., <200 nm) due to containment features (e.g., SA3 features) designed into the chiplet die and base wafer that confine the droplet to the bonding area with high precision. Such containment features may be characterized as alignment features, SA3 features, or the like. The liquid then evaporates, leaving the chiplet bonded to the base wafer at room temperature due to attractive surface forces (e.g., Van der Waals forces) between the dielectric regions on the chiplet and base wafer. An annealing step is then carried out to form and/or strengthen bonds between the metal pads (e.g., copper pads) dispersed between the dielectric regions, forming electrical interconnects between the chiplet and base wafer. The annealing step may also strengthen the bond between the dielectric regions.

The discussed liquid droplet is confined based on a wettability contrast between the hybrid bonding region and the surrounding areas. While surface texturing and trench creation are viable techniques to create the contrast, hydrophobic chemical coatings in the non-bonding surrounding areas offer effective and flexible surface energy tuning for wettability control. Notably, chemical hydrophobic coatings may be used alone or with other structure-based features. Challenges persist in using hydrophobic coatings and, in particular, in integrating hydrophobic coatings into the D2 W HB. For example, a pre-hybrid bond plasma treatment, which may clean the hybrid bonding surface and/or activate the surface by creating dangling bonds in the dielectric material, can damage or completely remove hydrophobic coatings such as organic coatings. Such damage and/or removal is noted in self-assembled monolayer (SAM), fluoropolymer, and other material systems. This damage and/or removal compromises droplet confinement, leading to large misalignment or bond failures, and can cause defects and other problems.

The techniques and structures discussed herein deploy cross-linkable hydrophobic materials with thickness tunability to resolve the difficulties of plasma treatment in the presence of the hydrophobic materials and structures. Such techniques and structures use high cross-link density, larger thickness, or a combination of both to provide a wider plasma operation window and preserve the hydrophobicity post plasma activation. For example, post-plasma treatment, the cross-linked hydrophobic coating or at least a thickness thereof remains for liquid droplet confinement during the discussed hybrid bonding process. Herein, cross-linked, hydrophobic thin films are deployed to coat the peripheral or surrounding areas of the hybrid bonding region on the base substrate, chiplet, or both for water droplet confinement. The coating may be performed using spin-on techniques, vapor phase deposition, or others. The thickness may be widely tunable between several nanometer to several hundreds of nanometers. The cross-linked coatings resolve the compatibility challenge of the susceptibility of patterned hydrophobic coatings to pre-bond activation treatments such as plasma treatments, which clean the hybrid bonding regions and increase the surface energy. The cross-linked material systems discussed herein, by leveraging cross-links, larger molecular weight, larger thickness, or the combined effect of all three minimizes the plasma damage to the hydrophobic coating and preserves the wettability contrast necessary for SA3.

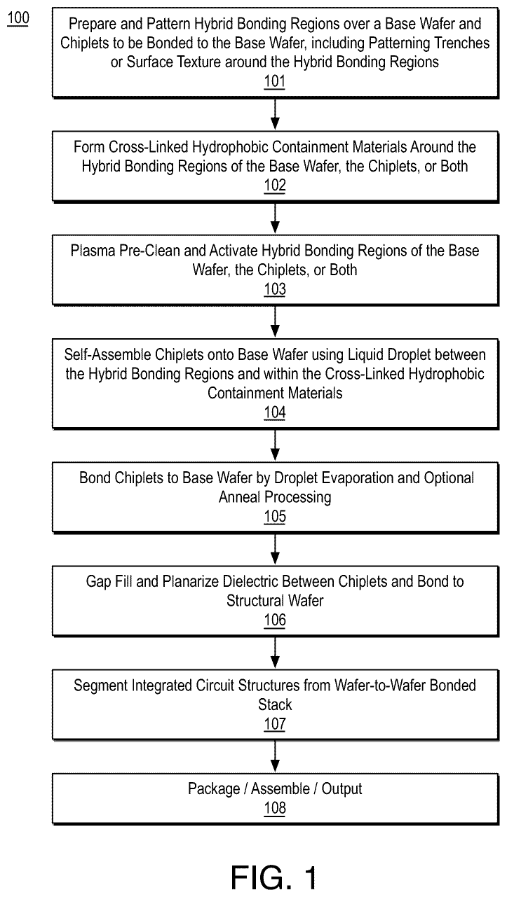

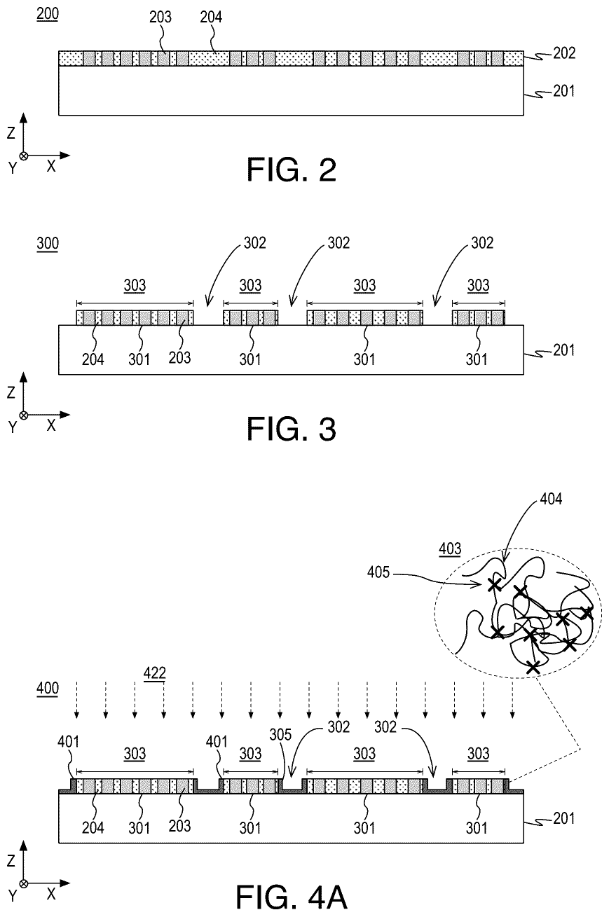

FIG. 1 provides a flow diagram illustrating an example process 100 for fabricating IC structures inclusive of 3D die stacks with hybrid bonding regions within containment features having cross-linked material systems, arranged in accordance with at least some implementations of the present disclosure. For example, process 100 may be implemented to fabricate IC structure 2100 or assembly structures including IC structure 2100 such as assembly structure 2200, or any other structure discussed herein. In the illustrated embodiment, process 100 includes one or more operations as illustrated by operations 101-108. However, embodiments herein may include additional operations, certain operations being omitted, or operations being performed out of the order provided. FIGS. 2, 3, 4A, 4B, 4C, 4D, 4E, 5-22 illustrate structures and components as the methods of process 100 are practiced.

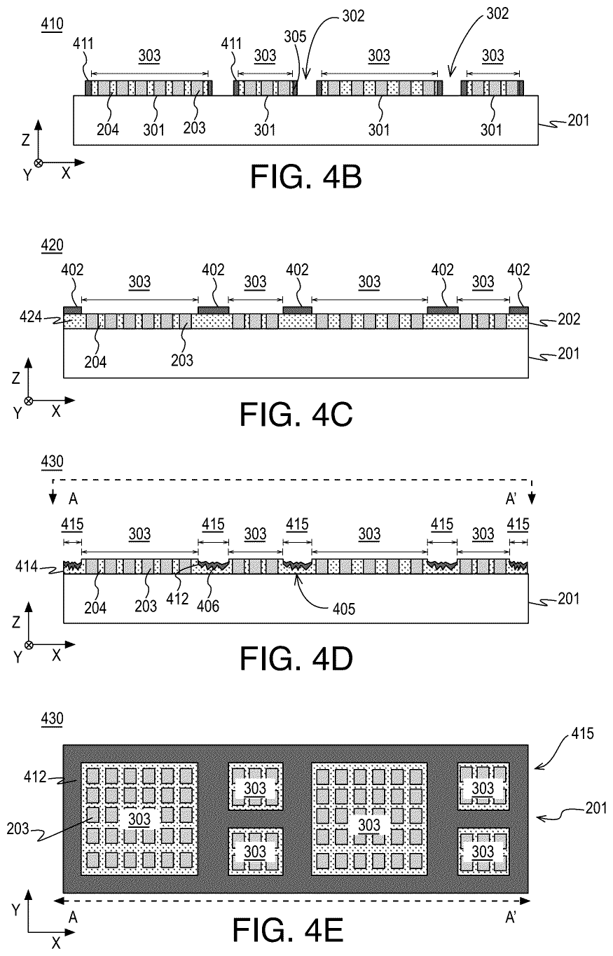

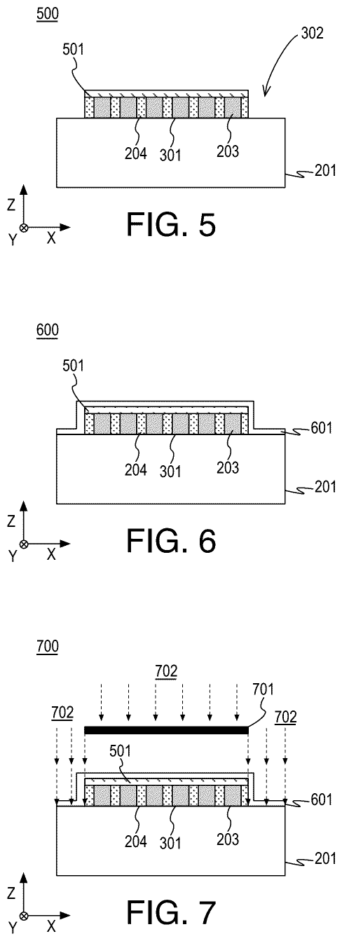

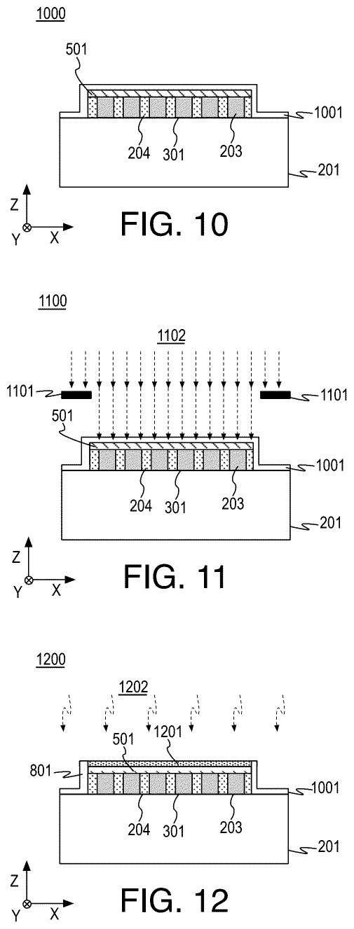

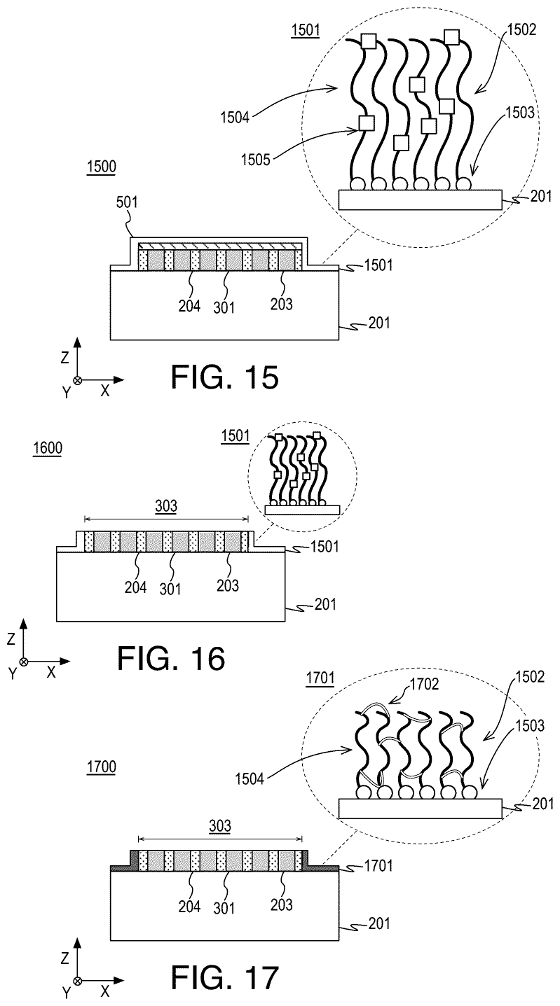

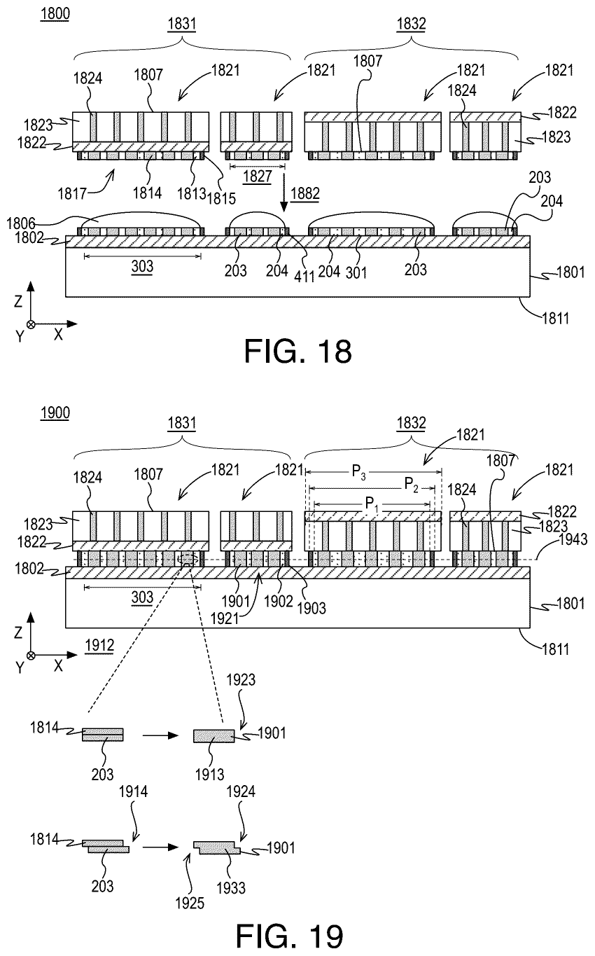

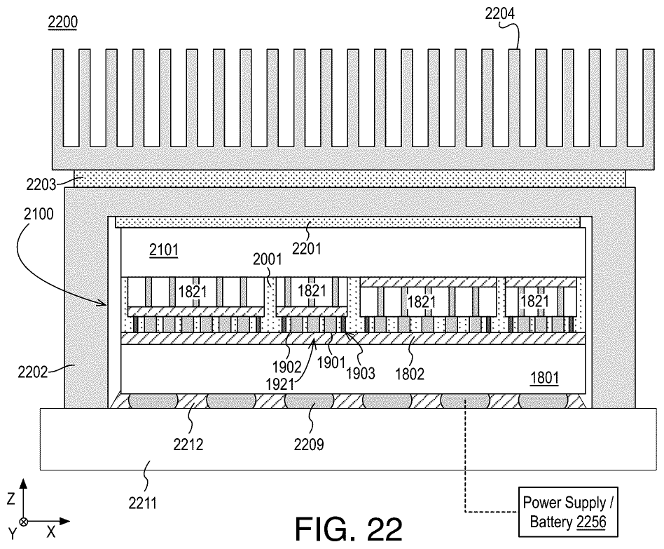

FIGS. 2, 3, 4A, 4B, 4C, and 4D are illustrations of cross-sectional side views of integrated circuit (IC) structures having different structural implementations of cross-linked material systems being prepared for self-alignment bonding, arranged in accordance with at least some implementations of the present disclosure. FIG. 4E illustrates a top-down view of the IC structure of FIG. 4D showing bonding regions defined by a hydrophobic pattern, arranged in accordance with at least some implementations of the present disclosure. FIGS. 5, 6, 7, 8, and 9 are illustrations of cross-sectional side views of the fabrication of IC structures having cross-linked material systems using selective UV treatment and lift-off techniques, arranged in accordance with at least some implementations of the present disclosure. FIGS. 10, 11, 12, 13, and 14 are illustrations of cross-sectional side views of the fabrication of IC structures having cross-linked material systems using selective heat treatment and lift-off techniques, arranged in accordance with at least some implementations of the present disclosure. FIGS. 15, 16, and 17 are illustrations of cross-sectional side views of the fabrication of IC structures having cross-linked material systems using self-assembled monolayers that are cross-linked after lift-off exposure of hybrid bonding regions, arranged in accordance with at least some implementations of the present disclosure. FIGS. 18, 19, 20, and 21 are illustrations of cross-sectional side views of hybrid bonding of IC dies to a base substrate, arranged in accordance with at least some implementations of the present disclosure. FIG. 22 is an illustration of a cross-sectional side view of an assembly structure similar to the IC structure of FIG. 21 after packaging and deployment of heat removal solutions, arranged in accordance with at least some implementations of the present disclosure.

Process 100 begins at operation 101, where hybrid bonding regions or areas are prepared and/or patterned. The hybrid bonding regions may be formed on or over a base substrate and/or on or over an IC die to be attached to a base substrate. As part of the preparation and patterning of the hybrid bonding regions, physical structures such as trenches or other texturing may surround the hybrid bonding regions. Processing continues at operation 102, where the hybrid bonding regions are surrounded by cross-linked material-based hydrophobic containment features. The hybrid bonding regions may thereby provide hydrophilic structures and the physical confinement features covered by cross-linked material-based hydrophobic containment features are to contain a liquid droplet (applied at operation 104) within the hydrophilic structures for alignment purposes. Processing continues at operation 103, where the hybrid bonding regions are prepped for bonding by a plasma pre-clean and activation step. Notably, the cross-linked material-based hydrophobic containment features formed at operation 102 can withstand this plasma pre-clean and activation step for improved downstream processing. Operations 101, 102, 103 are discussed in the following with respect to FIGS. 2, 3, 4A, 4B, 4C, 4D, 4E, 5-9, 10-14, and 15-17. In process 100, IC dies or chiplets are ultimately attached to a base wafer or substrate using self-alignment assisted assembly. Such attachment techniques place the IC dies or chiplets onto the base substrate quickly and with gross alignment and then use a liquid droplet between a hybrid bonding region of the placed IC die or chiplet and a corresponding hybrid bonding region of the base substrate to provide fine alignment using capillary forces. Such self-alignment bonding techniques allow for high throughput as high accuracy, high duration pick and place alignment is not needed.

FIG. 2 is an illustration of a cross-sectional side view of an IC structure 200 being prepared for self-alignment bonding. As shown, IC structure 200 includes a substrate 201 and a hybrid bonding layer 202 formed on substrate 201. Substrate 201 may be a base wafer (as discussed further herein below) or a structural wafer or panel or the like on which IC dies or chiplets are being prepared for hybrid bonding. For example, substrate 201 may be a monolithic material, a crystalline material, or a composite material structural material or substrate 201 may be a base substrate including an interconnect layer, optional device layer, and routing through substrate 201 for connection to an outside package or board.

Hybrid bonding layer 202 includes metal bond pads 203 interspersed in an inorganic dielectric material 204. Inorganic dielectric material 204 may be any suitable material for forming a dielectric-dielectric bond between hybrid bonding layer 202 and another hybrid bonding layer. As used herein, the term inorganic material indicates materials not having carbon as a foundational component or materials not having carbon-hydrogen bonds. In some embodiments, inorganic dielectric material 204 is silicon oxide. In some embodiments, inorganic dielectric material 204 is silicon nitride, silicon oxynitride, silicon carbonitride, or silicon carbide. In some embodiments, the out facing surface of hybrid bonding layer 202 may be planarized to a smooth finish for subsequent bonding. Metal bond pads 203 may be any suitable material for forming a bond between hybrid bonding layer 202 and another hybrid bonding layer and a suitable conductor for the application at hand. In some embodiments, metal bond pads 203 are copper but other metals may be used. In some embodiments, a bulk inorganic dielectric material is formed over substrate 201 and planarized. Metal bond pads 203 are then formed using any suitable technique or techniques such as single or dual damascene techniques.

FIG. 3 illustrates an IC structure 300 similar to IC structure 200 after formation of hydrophilic structures 301 to create wettability contrast for self-aligned bonding. As discussed, hydrophilic structures 301 include metal bond pads 203 (e.g., copper bond pads) interspersed in inorganic dielectric material 204, which may be silicon oxide, silicon nitride, silicon oxynitride, silicon carbonitride, or silicon carbide. Such materials are hydrophilic such that a liquid (e.g., water) will spread out on hydrophilic structures 301 as the liquid minimizes its surface energy and tends to stop at the edge of the trenches to achieve certain level of water confinement. Patterned hydrophilic structures 301 define hybrid bonding regions 303, which will be bonded to corresponding hybrid bonding regions to build 3D die stacks or structures, as discussed further herein below. Hydrophilic may be characterized as topographic structures, for example.

Hydrophilic structures 301 and openings or trenches 302 may be formed from hybrid bonding layer 202 using any suitable technique or techniques such as patterning a resist layer on or over hybrid bonding layer 202, etching the exposed portions of hybrid bonding layer 202 (e.g., via dry etch), and removing the resist layer. In some embodiments, the pattern of hydrophilic structures 301, as defined by hybrid bonding regions 303, matches a desired layout of chiplets or IC dies on substrate 201. In some embodiments, trenches 302 are formed using deep reactive ion etch processing or alternately through laser scribing.

FIG. 4A illustrates an IC structure 400 similar to IC structure 300 after formation of cross-linked material-based hydrophobic structures 401 adjacent hydrophilic structures 301. Cross-linked material-based hydrophobic structures 401 may be formed on sidewalls 305 of hydrophilic structures 301 and between hydrophilic structures 301 using any suitable technique or techniques such as those discussed with respect to FIGS. 5-9, FIGS. 10-14, or FIGS. 15-17 herein below. Cross-linked material-based hydrophobic structures 401, which may be characterized as hydrophobic spacers, hydrophobic materials, or the like may include any suitable cross-inked hydrophobic material (e.g., material that causes a liquid water droplet to have a contact angle of greater than 90°).

In some embodiments, cross-linked material-based hydrophobic structures 401 are or include a material 403 including a number polymer chains 404 cross-linked by a plurality of covalent bonds 405 (illustrated using a bold X in FIG. 4A) between polymer chains 404. Covalent bonds 405 between polymer chains 404 cross-link polymer chains 404 to provide cross-linked material-based hydrophobic structures 401. Notably, material 403 has a high cross-link density such as a cross-link density of between about 5×10⁻⁴ mol/cm³ and 2×10⁻³ mol/cm³. However, other cross-link densities may be used. The cross-link density may be measured or detected using any suitable technique or techniques such as nuclear magnetic resonance spectroscopy, swelling tests, mechanical analysis, thermal analysis, infrared (IR) probing, X-ray photoelectron spectroscopy (XPS), scanning electron microscope (SEM) imaging, transmission electron microscope (TEM) imaging, or others. In some embodiments, material 403 of cross-linked material-based hydrophobic structures 401 may be characterized as having network or network structure due to the cross linking of covalent bonds 405. In some embodiments, the network vs. linear structure (e.g., non-network) of material 403 can be determined by a swelling test such that a network can only swell in a suitable solvent, whereas a linear structure will fully dissolve in the solvent. The term suitable solvent indicates a solvent in which polymer chains 404 readily dissolve absent cross-linking.

Material 403 of cross-linked material-based hydrophobic structures 401 may be any suitable cross-linked material system having any suitable polymer chains 404 with active groups along polymer chains 404 and/or at the ends of polymer chains 404 to form covalent bonds 405. Herein, a covalent bond may be characterized based on the chemistry of one or both groups used to form the covalent bond. In some embodiments, polymer chains 404 are fluorinated polymer chains 404 having any chain length of carbon atoms having one or two fluorine atoms bonded thereto (e.g., a —CF₂—, —CF₂—, —CHF—, etc. backbone). In some embodiments, polymer chains 404 are non-fluorinated polymer chains 404 having any chain length of carbon atoms having two hydrogen atoms bonded thereto (e.g., a —CH₂—, —CH₂—, etc. backbone). At the end of the polymer chains and/or along the polymer chains, active thermal- or photo-curable functional groups are provided, which lead to cross-linking by covalent bonds 405 after such thermal- or photo-curing.

In some embodiments, such cross-linking is combined with a relatively large molecular weight to provide plasma processing resistance as discussed herein below. In some embodiments, polymer chains 404 have a chain length of 20 repeating units or more. In some embodiments, polymer chains 404 have a chain length of 50 repeating units or more. In some embodiments, polymer chains 404 have a chain length of 100 or more. In addition or in the alternative, cross-linked material-based hydrophobic structures 401 may have a relatively large thickness to provide plasma processing resistance. In some embodiments, cross-linked material-based hydrophobic structures 401 has a thickness (measured orthogonal from any suitable surface that cross-linked material-based hydrophobic structures 401 is on) of not less than 50 nm. In some embodiments, cross-linked material-based hydrophobic structures 401 has a thickness of not less than 100 nm. In some embodiments, cross-linked material-based hydrophobic structures 401 has a thickness of not less than 200 nm. Other thicknesses may be used.

As discussed, cross-linked material-based hydrophobic structures 401 may be any suitable material 403 including polymer chains 404 having a network structure due to covalent bonds 405. As used herein, the term polymer chain indicates a molecule (or macromolecule) including many repeating subunits. The term chain length indicates the number of monomers in each chain, which may be an average across material 403, for example. Notably, cross-linked material-based hydrophobic structures 401 include covalent bonds 405 that cross-link particular polymer chains 404. The term cross-link indicates a covalent bond (or multiple bonds) that link one polymer chain 404 to another polymer chain 404. Such covalent bonds may be direct to functional groups of polymer chains or they may be through intermediary molecules or atoms. As discussed, such cross-linked material-based hydrophobic structures 401 may be formed by ultraviolet (UV) curing, thermal curing, or plasma-induced cross-linking of self-assembled monolayer polymer chains 404. Exemplary materials for cross-linked material-based hydrophobic structures 401 are discussed further herein below with respect to the respective process of formation of the material system.

As discussed, cross-linked material-based hydrophobic structures 401 will contain a liquid within hybrid bonding regions 303 while hydrophilic structures 301 allow the liquid to spread out in hybrid bonding regions 303. For example, hydrophilic structures 301 may be inorganic materials such as silicon oxide, silicon nitride, silicon oxynitride, silicon carbonitride, or silicon carbide. Such materials are hydrophilic such that a liquid (e.g., water) will spread out on hydrophilic structures 301 as the liquid minimizes its surface energy. Hydrophobic structures such as cross-linked material-based hydrophobic structures 401, in contrast, will contain the liquid. Hydrophilic materials or surfaces cause a liquid droplet to have a contact angle of less than 90° (e.g., water on silicon oxide has a contact angle of ˜1-20°) while a hydrophobic structure causes a contact angle of greater than 90° in the liquid droplet.

Prior to such liquid droplet-based alignment and bonding, the top surface of IC structure 400 may be processed by a plasma activation 422 that cleans top surfaces of hybrid bonding regions 303 (e.g., top surfaces of metal bond pads 203 and inorganic dielectric material 204) and/or activates top surfaces of hybrid bonding regions 303. For example, the activation may form dangling bonds in inorganic dielectric material 204 to facilitate bonding. Plasma activation 422 may include any suitable plasma processing using any suitable chemistry. For example, plasma activation 422 may deploy a nitrogen (N₂), oxygen (O₂), hydrogen (H₂), argon (Ar), or other plasma using any suitable process parameters. Notably, absent cross-linked material-based hydrophobic structures 401, plasma activation 422 may disadvantageously remove all or significant portions of other hydrophobic material systems. However, deployment of cross-linked material-based hydrophobic structures 401 leaves such structures intact after plasma activation 422. In some embodiments, a thickness of cross-linked material-based hydrophobic structures 401 may be reduced due to plasma activation 422. In some embodiments, the thickness of cross-linked material-based hydrophobic structures 401 may reduce by not more than 50%. In some embodiments, the thickness of cross-linked material-based hydrophobic structures 401 may reduce by not more than 25%. In some embodiments, the thickness of cross-linked material-based hydrophobic structures 401 may reduce by not more than 10%. In some embodiments, the thickness may not be reduced by a detectable amount.

In the embodiment of FIG. 4A, hybrid bonding regions 303 are within hydrophobic structures 401 and trenches 302. Notably, trenches 302 are also hydrophobic structures as the trench resists the water from spreading over it. The embodiment of FIG. 4A offers the advantages of multiple and diverse hydrophobic structures (e.g., both material based, and structure based hydrophobic structures). FIGS. 4B-4D illustrate alternative hydrophilic structures and corresponding cross-linked material-based hydrophobic structures for the containment of a liquid within hybrid bonding regions 303.

FIG. 4B illustrates an IC structure 410 similar to IC structure 300 after formation of cross-linked material-based hydrophobic structures 411 adjacent hydrophilic structures 301. Cross-linked material-based hydrophobic structures 411 may be formed on sidewalls 305 of hydrophilic structures 301 (and absent a top surface of substrate 201 between hydrophilic structures 301) using any suitable technique or techniques. In some embodiments, a conformal cross-linked material-based hydrophobic material layer is formed on exposed surfaces of hydrophilic structures 301 and substrate 201 using, for example, spin coating or conformal vapor deposition followed by UV or thermal curing. The conformal cross-linked material-based hydrophobic material layer is then removed from the lateral or horizontal surfaces while the conformal hydrophobic material layer remains on sidewalls 305 via an anisotropic etch such as a dry etch or lithography and etch processing.

Cross-linked material-based hydrophobic structures 411 may include any cross-linked material discussed elsewhere herein. As discussed, cross-linked material-based hydrophobic structures 411 will contain a liquid within hybrid bonding regions 303 while hydrophilic structure 301 allows the liquid to spread out within hybrid bonding regions 303. In the embodiment of FIG. 4B, hybrid bonding regions 303 are within cross-linked material-based hydrophobic structures 411 and trenches 302.

FIG. 4C illustrates an IC structure 420 similar to IC structure 200 after formation of cross-linked material-based hydrophobic structures 402 to define hybrid bonding regions 303 as portions of hybrid bonding layer 202, which is also labeled as hydrophilic structure 424. Cross-linked material-based hydrophobic structures 402 may be formed using any suitable technique or techniques such as forming a conformal hydrophobic material layer on hybrid bonding layer 202 by spin coating or conformal vapor deposition followed by UV or thermal curing, and subsequently patterning the conformal hydrophobic material layer by patterning a resist layer on or over the hydrophobic material layer, etching the exposed portions of the hydrophobic material layer, and removing the resist layer. For example, the pattern of cross-linked material-based hydrophobic structures 402 defines hybrid bonding regions 303.

Cross-linked material-based hydrophobic structures 402 may include any cross-linked material discussed elsewhere herein. As discussed, cross-linked material-based hydrophobic structures 402 will contain a liquid within hybrid bonding regions 303 while hydrophilic structure 424 allows the liquid to spread out within hybrid bonding regions 303. In the embodiment of FIG. 4C, hybrid bonding regions 303 are within cross-linked material-based hydrophobic structures 402 and on particular areas or regions of hydrophilic structure 424. Such structures offer the advantages of cross-linked material-based hydrophobic structures 402 with relative ease of manufacture.

FIG. 4D illustrates an IC structure 430 similar to IC structure 200 after formation of hydrophobic structures 455 including roughened surfaces 406 and subsequent formation of cross-linked material hydrophobic structures 412. Hydrophobic structures 455 may be formed using any suitable technique or techniques such as surface texturing techniques inclusive of laser surface roughening. Roughened surfaces 406 may have any suitable surface roughness relative to the surface of hydrophilic structure 424 in hybrid bonding regions 303. In some embodiments, the surface roughness (i.e., measured as the deviations in the direction of the normal vector of a real surface from its ideal form) of roughened surfaces 406 is not less than twice the surface roughness of the surface of hydrophilic structure 424 in hybrid bonding regions 303. For example, a ratio of the roughnesses may be defined as the surface roughness of roughened surfaces 406 divided by the surface roughness of the surface of hydrophilic structure 424 in hybrid bonding regions 303. In some embodiments, the ratio is not less than two. In some embodiments, the ratio is not less than five, ten, or twenty. In some embodiments, the ratio is not less than 100. Other surface roughness ratios may be used.

Cross-linked material hydrophobic structures 412 may then be formed using any suitable technique or techniques such as forming a conformal cross-linked hydrophobic material layer on modified layer 414, and subsequently patterning the conformal hydrophobic material layer by patterning a resist layer on or over the hydrophobic material layer, etching the exposed portions of the hydrophobic material layer, and removing the resist layer. Cross-linked material hydrophobic structures 412 may include any cross-linked material discussed elsewhere herein. Hydrophobic structures 455, 412 contain a liquid within hybrid bonding regions 303 while hydrophilic structure 424 allows the liquid to spread out within hybrid bonding regions 303. Cross-linked material-based hydrophobic structures 412 aid, along with roughened surfaces 406, in the containment of a liquid within hybrid bonding regions 303 while hybrid bonding regions 303 allow the liquid to spread out. As shown in FIG. 4E, any of the previously discussed hydrophobic structures defines keep out regions or a hydrophobic pattern 415 that fully or nearly fully surrounds each of hybrid bonding regions 303 with hydrophobic structures.

FIG. 4E illustrates a top-down view of IC structure 430 showing hybrid bonding regions 303 defined by hydrophobic pattern 415. In the example of FIG. 4E, cross-linked material hydrophobic structures 412 and hydrophobic structures 455 provide containment within hybrid bonding regions 303 (with only cross-linked material hydrophobic structures 412 being visible in the top-down view). However, any of cross-linked material-based hydrophobic structures 401, 411, 402, 412 may provide the same hydrophobic pattern 415. As shown, hybrid bonding regions 303 may be the same or different sizes and hybrid bonding regions 303 define a chiplet or IC die layout on substrate 201, which underlies hydrophobic pattern 415 and hybrid bonding regions 303. In some embodiments, an IC die or chiplet is first gross aligned to each of hybrid bonding regions 303. This gross alignment may be performed by pick and place equipment and may be within, for example, 25-50 μm. A liquid droplet (e.g., water droplet) between each of hybrid bonding regions 303 and the corresponding IC die or chiplet then, via capillary forces, provides fine alignment (in a self-aligned manner) of the IC die or chiplet within each of hybrid bonding regions 303. This fine alignment may be to within, for example, 200 nm or less. Alternatively, chiplets may be diced from substrate 201 based on hydrophobic pattern 415 to provide IC dies or chiplets for bonding to a base substrate. Hydrophobic structure 415 surrounds the hybrid bonding region 303 (e.g., a metal pad region), but does not necessarily take up all spaces between hybrid bonding regions 303.

Discussion now turns to exemplary techniques for forming cross-linked material-based hydrophobic structures surrounding hybrid bonding regions. FIGS. 5, 6, 7, 8, and 9 are illustrate the fabrication of IC structures having cross-linked material systems using selective radiation treatment and lift-off techniques.

FIG. 5 illustrates an IC structure 500 similar to IC structure 200 after formation of a mask layer 501 and etch of portions of hybrid bonding layer 202 to fabricate hydrophilic structures 301. In FIGS. 5-17 a single hydrophilic structure 301 is illustrated for the sake of clarity of presentation. In some embodiments, mask layer 501 is a patterned photoresist. However, other materials or stacks of layers may be used. FIGS. 5-9 illustrate an exemplary process flow to fabricate photo-curable cross-linked hydrophobic materials coating on SA3 structures such as hydrophilic structure 301. In this context, cross-linked hydrophobic chemistry is used in combination with trench architectures as defined by trench 302 around hydrophilic structure 301. As discussed above trench 302 deep reactive ion etching or the like.

FIG. 6 illustrates an IC structure 600 similar to IC structure 500 after formation of a conformal UV-curable cross-linkable layer 601 over mask layer 501 and a top surface of substrate 201. Conformal UV-curable cross-linkable layer 601 may be any suitable photo-curable hydrophobic material. Although discussed with respect to UV curing, any photo curing may be used. In some embodiments, conformal UV-curable cross-linkable layer 601 is a dilute oligomeric resin solutions that is spun-on at the wafer level, which forms conformal UV-curable cross-linkable layer 601 as a thin and conforming film over the underlying structures. Although discussed with respect to spin-on deposition, vapor deposition that renders cross-linked hydrophobic network can be also used. For example, CVD of perfluorodiacrylate (PFDA) or polyaniline, or PECVD of plasma polymerized films including HMDSO siloxanes. For these films, the thickness may be in the lower end <50 nm due to lift-off considerations and follow the process flow as shown in FIG. 3.

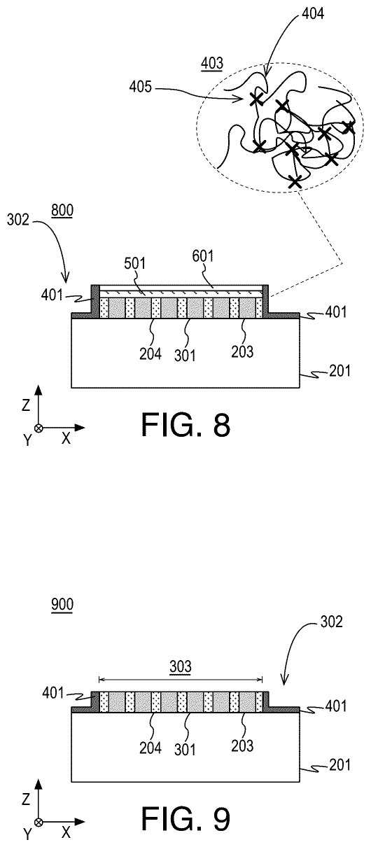

FIG. 7 illustrates an IC structure 700 similar to IC structure 600 during selective exposure 702 of formation of conformal UV-curable cross-linkable layer 601. Such selective exposure 702, as defined by mask 701, may be performed using any suitable technique or techniques such as UV (or other wavelength of radiation) exposure in a scanner or maskless direct write lithography tool. FIG. 8 illustrates an IC structure 800 similar to IC structure 700 after selective exposure 702 and selective cross-linking to form cross-linked material-based hydrophobic structures 401. As shown, the resin, for example, of conformal UV-curable cross-linkable layer 601 cross-links on the bonding mesa sidewalls of hydrophilic structures 301 and on the exposed bottoms of trenches 302, but remains non-cross-linked on top of hydrophilic structures 301.

In some embodiments, material 403 includes a perfluoropolyether acrylate. In some embodiments, material 403 includes a siloxane acrylate. In some embodiments, material 403 includes a silicone acrylate. In some embodiments, material 403 includes a vinyl-terminated silicone. In some embodiments, material 403 includes a hydride-terminated silicone. In some embodiments, material 403 includes a chain-terminated polyolefin derivative. In some embodiments, material 403 includes perfluorodiacrylate. In some embodiments, material 403 includes hexamethyldisiloxane. For example, curable hydrophobic chemistries include perfluoropolyether acrylates, siloxane/silicone acrylates, vinyl/hydride-terminated silicones, end- or side chain-terminated polyolefin derivatives, and others.

In some embodiments, covalent bonds 405 between polymer chains 404 are sulfur to carbon covalent bonds. In some embodiments, covalent bonds 405 between polymer chains 404 are oxygen to carbon covalent bonds. In some embodiments, covalent bonds 405 between polymer chains 404 are nitrogen to carbon covalent bonds. In some embodiments, covalent bonds 405 between polymer chains 404 are acrylate bonds. In some embodiments, covalent bonds 405 between polymer chains 404 are methacrylate bonds. In some embodiments, material 403 includes sulfonium salt. In some embodiments, material 403 includes antimonate salt. Such salts may be produced due to the presence of photoacids, for example. In some embodiments, material 403 includes a peroxide. In some embodiments, material 403 includes a quinone. Such materials may be present as photo-initiators (e.g., a molecule that creates a reactive species when exposed to the radiation of selective exposure 702. In some embodiments, material 403 includes platinum, which may be a catalyst in a vinyl- or hydride-terminated silicon reaction.

FIG. 9 illustrates an IC structure 900 similar to IC structure 800 after lift-off of mask layer 501 and conformal UV-curable cross-linkable layer 601. Such lift of processing may be performed using any suitable technique or techniques. In some embodiments, during photoresist stripping, conformal UV-curable cross-linkable layer 601 on hydrophilic structures 301 (e.g., on bonding mesas), which is not cross-linked, is readily removed. For example, conformal UV-curable cross-linkable layer 601 may be removed using organic solvents or alkali aqueous solution since it remains soluble in organic solvents or susceptible to delamination/cleavage in alkali aqueous solution. The removal of conformal UV-curable cross-linkable layer 601 (while cross-linked material-based hydrophobic structures 401 remains) allows access of mask layer 501 (e.g., photoresist) by an etchant/stripper to remove mask layer 501. This leaves a substantially clean hybrid bonding region 303. As shown, cross-linked material-based hydrophobic structures 401 is on sidewalls 305 of hydrophilic structures 301 and on the bottom of trench 302. As discussed, cross-linked material-based hydrophobic structures 401 not substantially impacted or removed by the etchant/stripper. The flow of FIGS. 5-9 offers the advantage allowing of this flow is that the hydrophobic film can be of increased thicknesses (e.g., greater than 50 nm, greater than 100 nm, or greater than 200 nm) without compromising the effectiveness of stripping mask layer 501.

Although discussed with respect to spin-on deposition followed by selective UV cure, chemical vapor deposition (CVD) or plasma-enhanced chemical vapor deposition (PECVD) that renders cross-linked hydrophobic network may be used. In some embodiments, CVD of perfluorodiacrylate (PFDA), crosslinked polyaniline, or PECVD of plasma polymerized films including hexamethyldisiloxane (HMDSO). In such contexts, for these films, the thickness may be in the lower end (e.g., not more than 50 nm) due to lift-off considerations. For example, such cross-linked hydrophobic networks may be lifted off as discussed with respect to FIG. 9 despite the film having a network structure throughout the film.

As discussed, material 403 may be either fluorinated or non-fluorinated and may include photo-curable functional groups leading to cross-linked, network polymeric structures in the patterned thin films around the bonding area. Cross-links, larger molecular weight, larger thickness or the combined effect of all three minimize the plasma damage discussed with respect to FIG. 4A.

Discussion now turns to FIGS. 10, 11, 12, 13, and 14, which illustrate the fabrication of IC structures having cross-linked material systems using selective heat treatment and lift-off techniques.

FIG. 10 illustrates an IC structure 1000 similar to IC structure 500 after formation of a conformal thermo-curable cross-linkable layer 1001 over mask layer 501 and a top surface of substrate 201. Conformal thermo-curable cross-linkable layer 1001 may be any suitable thermo-curable hydrophobic material. In some embodiments, thermo-curable cross-linkable layer 1001, upon UV exposure, is less likely to cross-link due to the photo-induced release of radical quencher (e.g., benzophenone), prohibiting a cross-linking reaction during thermal cure after UV exposure.

FIG. 11 illustrates an IC structure 1100 similar to IC structure 1000 during selective exposure 1102 of formation of conformal thermo-curable cross-linkable layer 1001. Such selective exposure 1102, as defined by mask 1101, may be performed using any suitable technique or techniques such as UV (or other wavelength of radiation) exposure in a scanner or maskless direct write lithography tool. FIG. 12 illustrates an IC structure 1200 similar to IC structure 1100 after selective exposure 1102 and during thermal processing 1202. As discussed, selective exposure 1102 releases chemicals that prohibit the cross-linking reaction, e.g., a radical quencher (e.g., benzophenone) in modified region 1201 of conformal thermo-curable cross-linkable layer 1001. This radical quencher reduces or eliminates cross-linking during thermal processing 1202. Thermal processing 1202 may be performed at any elevated temperature for any duration to cross-link conformal thermo-curable cross-linkable layer 1001 outside of modified region 1201.

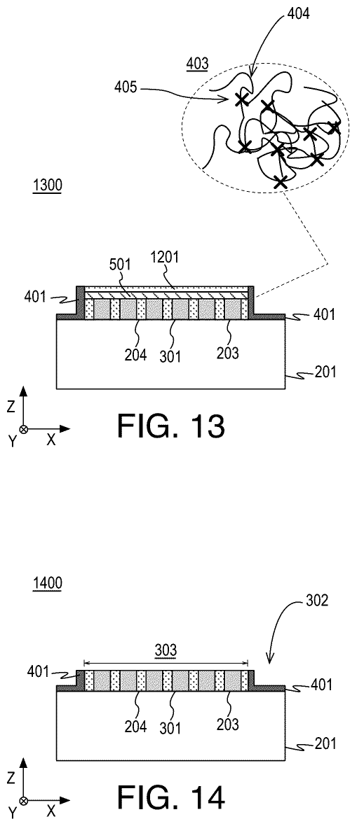

FIG. 13 illustrates an IC structure 1300 similar to IC structure 1200 after thermal processing 1202, based on prior selective exposure 1102, selectively cross-links conformal thermo-curable cross-linkable layer 1001 absent the radical quencher, to form cross-linked material-based hydrophobic structures 401. As shown, the polymer chains of conformal thermo-curable cross-linkable layer 1001 cross-link on the sidewalls of hydrophilic structures 301 and on the exposed bottoms of trenches 302, but remains non-cross-linked on top of hydrophilic structures 301.

Material 403 of cross-linked material-based hydrophobic structures 401 may be any material system discussed herein. In some embodiments, material 403 includes a perfluoropolyether acrylate, a siloxane acrylate, a silicone acrylate, a vinyl-terminated silicone, a hydride-terminated silicone, a chain-terminated polyolefin derivative, perfluorodiacrylate, polyaniline, or hexamethyldisiloxane. For example, curable hydrophobic chemistries include perfluoropolyether acrylates, siloxane/silicone acrylates, vinyl/hydride-terminated silicones, end- or side chain-terminated polyolefin derivatives, and others. In some embodiments, covalent bonds 405 between polymer chains 404 are sulfur to carbon covalent bonds, acrylate bonds, or methacrylate bonds.

FIG. 14 illustrates an IC structure 1400 similar to IC structure 1300 after lift-off of mask layer 501 and modified region 1201. Such lift of processing may be performed using any suitable technique or techniques such as photoresist stripping techniques. For example, modified region 1201, which is not cross-linked, may be removed using organic solvents or alkali aqueous solution. The removal of modified region 1201 allows access of mask layer 501 (e.g., photoresist) by an etchant/stripper to remove mask layer 501, leaving a substantially clean hybrid bonding region 303. As shown, cross-linked material-based hydrophobic structures 401 is on sidewalls 305 of hydrophilic structures 301 and on the bottom of trench 302. As discussed, cross-linked material-based hydrophobic structures 401 not substantially impacted or removed by the etchant/stripper.

As discussed, material 403 may be either fluorinated or non-fluorinated and may include photo-curable functional groups leading to cross-linked, network polymeric structures in the patterned thin films around the bonding area. Cross-links, larger molecular weight, larger thickness or the combined effect of all three minimize the plasma damage discussed with respect to FIG. 4A. FIGS. 10-14 illustrate a process flow using thermal curing such that UV exposure (or other radiation exposure) creates the chemical contrast, such that the exposed area is less likely to cross-link due to the photo-induced release of chemical agents, e.g., a radical quencher, which prohibits cross-linking reaction afterwards. When later exposed to an elevated temperature, only the unexposed areas on the side wall of the hybrid bonding mesa and the trench bottom between mesas are cross-linked while the hydrophobic films on top of the hybrid bonding mesas remain soluble for lift-off removal.

Discussion now turns to FIGS. 15, 16, and 17, which illustrate the fabrication of IC structures having cross-linked material systems using self-assembled monolayers that are cross-linked after lift-off exposure of hybrid bonding regions.

FIG. 15 illustrates an IC structure 1500 similar to IC structure 500 after formation of a cross-linkable self-assembled monolayer (SAM) 1501 over mask layer 501 and a top surface of substrate 201. Cross-linkable SAM 1501 may include any suitable hydrophobic SAM having molecules 1502 each having a head group 1503 to couple to mask layer 501 and substrate 201 and an optional tail group 1504 to provide hydrophobicity. In some embodiments, head group 1503 is one of silane, thiol, alkanoic acid, phosphonic acid. In some embodiments, group 1504 is one of an aliphatic chain or a fluorinated chain. For example, cross-linkable SAM 1501 may include small molecules with a head-tail structure, where head group 1503 can be silane, thiol, hydroxyl, an amino group, a polyoxyethyline group, alkanoic acid, or phosphonic acid, to anchor the molecule and tail group 1504 is an aliphatic chain, perfluoropolyether acrylate, or a fluorinated chain with, for example, 1 to 18 carbons that provides the desired hydrophobicity. Furthermore, each of molecules 1502 includes one or more functional groups 1505 such as vinyl groups, acrylate groups, or the like that may cross-link during activation using heat or light.

FIG. 16 illustrates an IC structure 1600 similar to IC structure 1500 after lift-off of mask layer 501 and a portion or region of cross-linkable SAM 1501. Such lift of processing may be performed as discussed above using photoresist stripping techniques. FIG. 17 illustrates an IC structure 1700 similar to IC structure 1600 after cross-linking of cross-linkable SAM 1501 to form cross-linked SAM 1701 having covalent bonds 1702. Such cross-linking may be at or between functional groups 1505, for example. The formation of cross-linked SAM 1701 may be performed using any suitable technique or techniques such application of heat or light including thermos-activation and photo-activation processing. As discussed, molecules 1502 of cross-linked SAM 1701 may have a head structure or head group 1503 and a tail structure or tail group 1504 such that head structure or head group 1503 includes one of a silane, a thiol, an alkanoic acid, or a phosphonic acid, and the tail structure or tail group 1504 includes one of an aliphatic chain or a fluorinated chain. In addition, molecules 1502 of cross-linked SAM 1701 may include reacted and unreacted functional groups such as vinyl groups or acrylate groups (not shown in FIG. 17).

As discussed with respect to FIGS. 15-17, in some embodiments, SAMs with tails modified with functional groups (e.g., vinyl, acrylate, etc.) may be deployed for cross-link upon activation by light or heat. Unlike conventional SAMs forming oriented brush-like structure on the modified surface, the crosslinks of cross-linked SAM 1701 act as pins to strengthen the thin film. This in turn provides robustness to withstand plasma activation 422 (e.g., pre-bond activation, refer to FIG. 4A).

Returning to FIG. 1, process 100 continues at operation 104, where IC dies or chiplets are self-assembled onto a base wafer using a liquid droplet between hybrid bonding regions and within the cross-linked material based hydrophobic containment features prepared at operation 102. In some embodiments, the water droplet is applied to a hydrophilic hybrid bonding region over a base substrate. The IC die hydrophilic hybrid bonding region is placed on or over the hydrophilic bonding region of the base substrate (using gross alignment) and the interplay of the droplet, the hydrophilic bonding regions, and the cross-linked material based hydrophobic containment features cause the IC die to self-align with high accuracy.

FIG. 18 is an illustration of a cross-sectional side view of an IC structure 1800 during self-alignment bonding. As shown, IC structure 1800 includes hydrophilic structures 301 on or over a base substrate 1801 and cross-linked material-based hydrophobic structures 411 adjacent hydrophilic structures 301 and also on or over base substrate 1801. Although illustrated with respect to hydrophilic structures 301 and cross-linked material-based hydrophobic structures 411, any hydrophilic structures and hydrophobic structures discussed herein may be deployed in the following structures. Cross-linked material-based hydrophobic structures 411 and adjacent hydrophilic structures 301 may be formed over base substrate 1801 using any suitable technique or techniques discussed above.

As shown, base substrate 1801 includes an active layer 1802. Active layer 1802 (or an active surface) includes a device layer and/or an interconnect layer. For example, a device layer may include transistors, capacitors, or other IC devices. An interconnect layer may be over the device layer and may include metallization levels that interconnect the devices of the device layer and provide routing to outside devices. In some embodiments, base substrate 1801 includes active devices in active layer 1802 and routing from active layer 1802 to a backside surface 1811 of base substrate 1801. In some embodiments, base substrate 1801 includes routing from active layer 1802 to backside surface 1811, and is absent active devices. Base substrate 1801 may include any suitable material or materials such as a semiconductor material such as monocrystalline silicon (Si), germanium (Ge), silicon germanium (SiGe), III-V materials (e.g., gallium arsenide (GaAs)), silicon carbide (SiC), sapphire (Al₂O₃), or any combination thereof. As discussed, a base substrate, base wafer, or base die indicates a substrate having active or passive electrical features. In some embodiments, a multi-level stack of IC dies is formed over base substrate 1801 using die-to-wafer bonding and 3D die complexes are segmented from base substrate 1801 such that each 3D die complex includes a portion of base substrate 1801 and the pertinent attached chiplets over the segmented portion of base substrate 1801.

Furthermore, each of IC dies 1821 includes a substrate 1823, an active layer 1822, and through vias 1824 extending between active layer 1822 and a backside surface 1807 of each of IC dies 1821. Active layer 1822 (or an active surface), similar to active layer 1802, includes a device layer and/or an interconnect layer. For example, the device layer may include transistors, capacitors, or other IC devices. The interconnect layer may be over the device layer and may include metallization levels that interconnect the devices of the device layer and provide routing to outside devices. Substrate 1823 may include any suitable material or materials such as a semiconductor material such as monocrystalline silicon (Si), germanium (Ge), silicon germanium (SiGe), III-V materials (e.g., gallium arsenide (GaAs)), silicon carbide (SiC), sapphire (Al₂O₃), or any combination thereof. Backside surface 1807 is opposite active layer 1822 and may be characterized as a non-active surface.

On or over each of IC dies 1821, hydrophilic structures 1817 (analogous to hydrophilic structures 301) and cross-linked material-based hydrophobic structures 1815 (analogous to cross-linked material-based hydrophobic structures 411) are formed as discussed herein above to define hybrid bonding regions 1827. For example, hydrophilic structures 1817 include metal bond pads 1814 and inorganic dielectric material 1813, which may have any characteristics discussed with respect to metal bond pads 203 and inorganic dielectric material 204. Similarly, cross-linked material-based hydrophobic structures 1815 may have any characteristics discussed with respect to cross-linked material-based hydrophobic structures 411 and, although illustrated with respect to cross-linked material-based hydrophobic structures 1815 being similar to cross-linked material-based hydrophobic structures 411, any hydrophobic structures discussed herein may be deployed. Hydrophilic structures 1817 and cross-linked material-based hydrophobic structures 1815 may be formed over a wafer including one or more of IC dies 1821 using the techniques discussed above, and IC dies 1821 may be segmented (e.g., diced) from the wafer for pick and place onto hybrid bonding regions 303, for example. The combination of hydrophilic structures/hydrophobic structures over base substrate 1801 and the combination of hydrophilic structures/hydrophobic structures on IC dies 1821 may be the same (as shown) or they may be different.

As shown, liquid droplets 1806 are placed on hybrid bonding regions 303 of hydrophilic structures 301 (or on bonding regions 1827 of hydrophilic structures 1817). Liquid droplets 1806 may be any suitable liquid such as water of any suitable volume. Hybrid bonding regions 303 and hybrid bonding regions 1827 are brought together using, for example, pick and place of IC dies 1821. As shown, liquid droplets 1806 spread out on hybrid bonding regions 303 (or hybrid bonding regions 1827) and are contained by cross-linked material-based hydrophobic structures 411 (or cross-linked material-based hydrophobic structures 1815). IC dies 1821 are grossly and advantageously quickly aligned to hybrid bonding regions 303 and liquid droplets 1806 by pick and place 1882, confined by the self-alignment assisting features discussed herein, quickly fine align each of IC dies 1821 to the corresponding hybrid bonding region 303.

IC dies 1821 may be fabricated and attached such that they are in a face-down configuration 1831 or a face-up configuration 1832. In face-down configuration 1831, active layer 1802 and active layer 1822 are adjacent one another and are directly connected by a hybrid bond therebetween, as discussed further below. Advantageously, through vias 1824 (which may be characterized as through substrate vias or through silicon vias, TSVs), have backside connections on or over backside surface 1807 such that routing from the hybrid bond and active layer 1822 is provided to additional IC dies in the stack (e.g., extending in the z-dimension). In face-up configuration 1832, active layer 1822 is opposite substrate 1823 with respect to active layer 1822. In such contexts, through vias 1824 again have backside connections on or over backside surface 1807 such that routing from the hybrid bond may be provided to active layer 1822, and then to additional IC dies in the stack (e.g., extending in the z-dimension).

Returning to FIG. 1, process 100 continues at operation 105, where the IC dies or chiplets are bonded to the base substrate or wafer by evaporating the liquid droplets and optional anneal processing. For example, the liquid droplet applied at operation 102 evaporates relatively quickly after alignment and the inorganic materials hold the IC dies or chiplets in place due to, for example, Van der Waals forces. A subsequent anneal operation may be performed to bond the IC dies or chiplets to the bonding regions of the structural wafer by melding metal bond pads and the inorganic materials therebetween.

FIG. 19 is an illustration of a cross-sectional side view of an IC structure 1900 similar to IC structure 1800 after liquid droplets 1806 evaporate and after bonding to form composite metal structures 1901 and a composite dielectric portion 1902 between each of IC dies 1821 and base substrate 1801. As shown, IC structure 1900 includes base substrate 1801 coupled to active layers 1822 or backside surfaces 1807 of each IC die 1821, depending on whether each IC dies was in face-down configuration 1831 or face-up configuration 1832 during bonding.

As shown, the discussed hybrid bonding forms composite metal structures 1901 and a composite dielectric portion 1902 across a bonding plane 1943. Thereby, a hybrid bond 1921 between IC dies 1821 and base substrate 1801 is formed. Each hybrid bond 1921 includes composite metal structures 1901 and composite dielectric portion 1902. Composite dielectric portion 1902 may be characterized as an inorganic material, an inorganic bond layer, an inorganic bonding material, or the like. As shown, each hybrid bond 1921 is surrounded by composite cross-linked material-based hydrophobic structures 1903 or by the pertinent hydrophobic structures deployed in forming hybrid bond 1921.

As shown in insert 1912, in some embodiments, adjacent metal pads are annealed to form a composite metal structure 1913 (one of composite metal structures 1901) such that metal structure 1913 has a substantially aligned sidewalls 1923. However, in other embodiments, adjacent metal pads 203, 1814 have a misalignment 1914 during anneal and form a composite metal structure 1933 such that metal structure 1933 has a substantially misaligned sidewalls and therefore metal structure 1933 includes a jut 1924 and an overhang 1925. For example, the sidewall of metal structure 1933 may have substantially vertical sidewall portions and a substantially horizontal sidewall portion (e.g., at jut 1924 and overhang 1925).

As discussed, each hybrid bond 1921 is surrounded (entirely or mostly, i.e., >90%) by cross-linked material-based hydrophobic structures 1903. In the context of FIG. 19, cross-linked material-based hydrophobic structures 1903 are formed of hydrophobic structures 401, 1815, though the materials of cross-linked material-based hydrophobic structures 401, 1815 may not combine or meld. As shown in FIG. 19, hydrophobic structure 1903 extends around a perimeter P1 of hybrid bond 1921 (refer to FIG. 4E). As used herein, the term perimeter is used in its ordinary meaning to indicate an outer boundary of hydrophobic structure 1903 in the x-y plane. For perimeters that are not taken in the same plane, such perimeters are projected into the same plane for determination of their dimensions. Furthermore, an outer perimeter P2 of hydrophobic structure 1903 is fully within an outer perimeter P3 of IC die 1821. It is noted that a single continuous hydrophobic structure 1903 may surround hybrid bond 1921 or multiple discontinuous cross-linked material-based hydrophobic structures 1903 may surround hybrid bond 1921.

Returning to FIG. 1, process 100 continues at operation 106, where a gap fill dielectric is formed between the IC dies and planarized to provide a planar top surface and the structure is attached to a structural substrate such as a structural wafer. In some embodiments, the gap fill dielectric is an inorganic dielectric material such as silicon nitride, silicon oxynitride, silicon carbonitride, or silicon carbide. In some embodiments, the gap fill dielectric is composite materials such as the molding compound or other spin-on dielectrics. The gap fill dielectric may be formed using any suitable technique or techniques such as deposition techniques followed by planarization. In some embodiments, the IC structure is bonded to the structural substrate in a wafer-to-wafer bond using an adhesive, an adhesive tape, a dielectric bond, a metal-metal bond, or the like. The structural substrate may be a structural wafer or panel or the like that is absent any active or passive electrical features. For example, the structural substrate may be a monolithic material, a crystalline material, or a composite material. In some embodiments, the structural substrate is monocrystalline silicon such as a silicon wafer. In some embodiments, the structural substrate is or includes germanium, silicon germanium, silicon carbide, or sapphire, or a composite material.

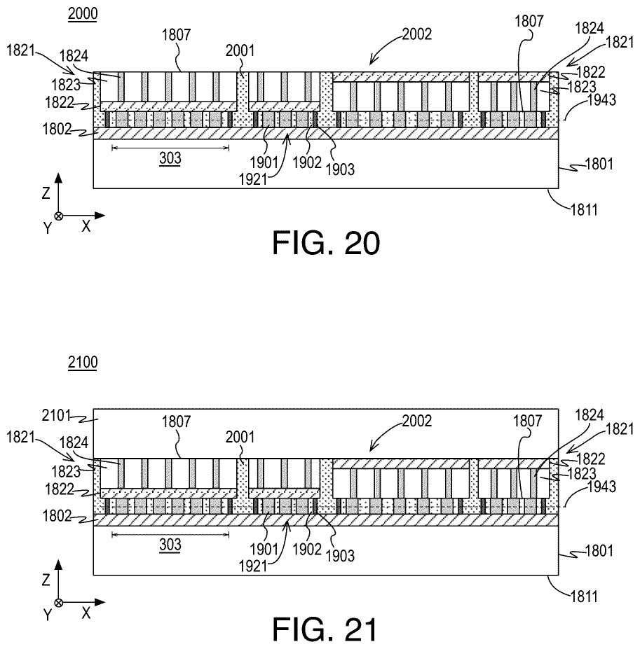

FIG. 20 is an illustration of a cross-sectional side view of IC structure 2000 similar to IC structure 1900 after forming inorganic dielectric 2001 and a substantially planar surface 2002. As shown, inorganic dielectric 2001 may be deposited as a fill material using any suitable technique or techniques such as vapor deposition techniques. The fill material is then planarized using grinding and chemical mechanical polishing techniques, to form planar surface 2002. Inorganic dielectric 2001 may be any material suitable dielectric material such as silicon oxide, silicon nitride, silicon oxynitride, silicon carbonitride, silicon carbide, or combinations thereof (e.g., a layer of one of those materials covered by a second layer of another one of those materials). Although inorganic dielectric materials may be advantageous, organic dielectrics or composite materials comprised of organic matrix and inorganic filler materials may be deployed. As discussed below, planar surface 2002 provides a surface for a subsequent level of IC dies or chiplets in a multi-level 3D die stack.

FIG. 21 is an illustration of a cross-sectional side view of IC structure 2100 similar to IC structure 2000 after bonding IC structure 2000 to a structural substrate 2101. Structural substrate 2101 may be bonded to IC structure 1100 using an adhesive, an adhesive tape, dielectric fusion bond, metal-metal bond or the like (not shown). Structural substrate 2101 may be a structural wafer or panel and is absent any active or passive electrical features. In some embodiments, structural substrate 2101 is or includes monocrystalline, germanium, silicon germanium, silicon carbide, or sapphire and composite materials. In some embodiments, structural substrate 2101 provides structural support during further processing (e.g., dicing, packaging, assembly, etc.). For example, base substrate 1801 may be thinned while IC structure 2000 is mounted to structural substrate 2101. After such processing and during deployment in an electronic device, structural substrate 2101 may provide a heat conduction path while continuing to provide structural support.

Returning to FIG. 1, process 100 continues at operation 107, where the integrated circuit structure is segmented (or diced) from the wafer-to-wafer bonded stack. For example, IC structure 2100, or any other IC structure discussed herein may be segmented from a wafer using known dicing techniques. Process 100 continues at operation 108, where the resultant device (e.g., IC structure) may be packaged, assembled, and implemented in any suitable form factor device such as a laptop, a netbook, a notebook, an ultrabook, a smartphone, a tablet, a personal digital assistant, an ultra-mobile PC, a mobile phone, a desktop computer, a server, a printer, a scanner, a monitor, a set-top box, an entertainment control unit, a digital camera, a portable music player, a digital video recorder, or the like.

FIG. 22 illustrates an example microelectronic device assembly 2200 including a 3D die stack having a hybrid bond with a cross-linked hydrophobic material around an outer perimeter of the hybrid bond, in accordance with some embodiments. For example, FIG. 22 is an illustration of a cross-sectional side view of an assembly structure similar to IC structure 2100 after packaging and deployment of heat removal solutions, As shown, IC structure 2100 may be incorporated into microelectronic device assembly 2200. Although illustrated with respect to the cross-linked hydrophobic structures of FIG. 4B, IC structure 2100 and, in turn, microelectronic device assembly 2200, may include any cross-linked hydrophobic structures discussed herein. Furthermore, microelectronic device assembly 2200 may deploy any IC structure discussed herein. Microelectronic device assembly 2200 may include any number of IC structures 2100 mounted to a substrate 2211 via interconnects 2209, which are optionally embedded in a mold or underfill material 2212. Substrate 2211 may be a package substrate, interposer, or board (such as a motherboard). Any number of IC structures 2100 having the same or different cross-linked hydrophobic structures may be attached to substrate 2211.

Microelectronic device assembly 2200 further includes a power supply 2256 coupled to one or more of substrate 2211 (i.e., a board, package substrate, or interposer), IC dies 1821 and/or other components of microelectronic device assembly 2200. Power supply 2256 may include a battery, voltage converter, power supply circuitry, or the like. Microelectronic device assembly 2200 further includes a thermal interface material (TIM) 2201 disposed on a top surface of structural substrate 2101. TIM 2201 may include any suitable thermal interface material and may be characterized as TIM 1. Integrated heat spreader 2202 having a surface on TIM 2201 extends over IC structure 1200 and is mounted to substrate 2211. Microelectronic device assembly 2200 further includes a TIM 2203 disposed on a top surface of integrated heat spreader 2202. TIM 2203 may include any suitable thermal interface material and may be characterized as TIM 2. TIM 2201 and TIM 2203 may be the same materials, or they may be different. A heat sink 2204 (e.g., an exemplary heat dissipation device or thermal solution) is on TIM 2203 and dissipates heat. Microelectronic device assembly 2200 may be used in desktop and server form factors. In other contexts, a heat solution such as a heat pipe or heat spreader may be mounted directly on TIM 2201. Such assemblies may be used in smaller form factor devices. Other heat dissipation devices may be used.

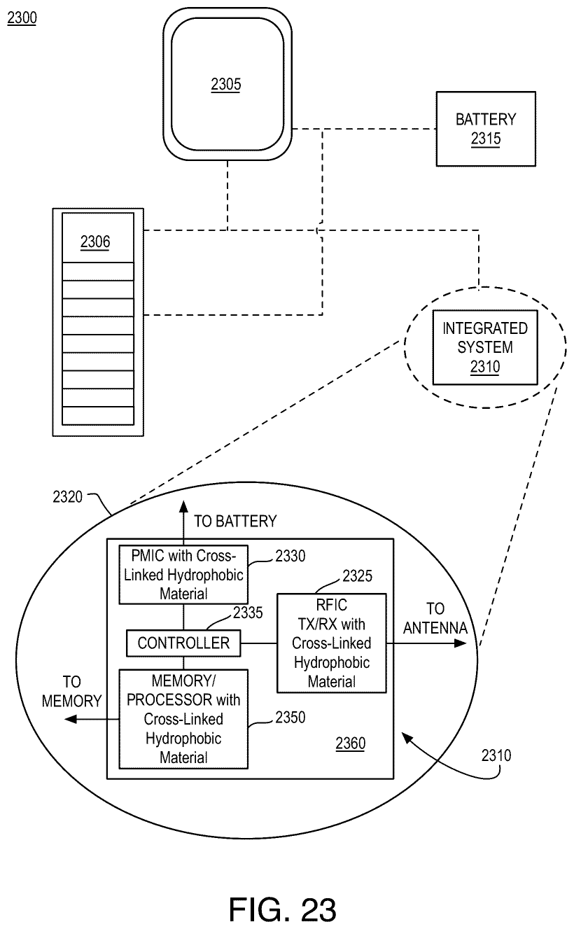

FIG. 23 illustrates an example microelectronic device assembly 2300 including a 3D die stack having a hybrid bond with a cross-linked hydrophobic material around an outer perimeter of the hybrid bond, in accordance with some embodiments. The system may be a mobile computing platform 2305 and/or a data server machine 2306, for example. Either may employ a component assembly including an IC structure as described herein. Server machine 2306 may be any commercial server, for example, including any number of high-performance computing platforms disposed within a rack and networked together for electronic data processing, which in the exemplary embodiment includes an integrated circuit (IC) die assembly 2350 including a 3D die stack having a hybrid bond with a cross-linked hydrophobic material around an outer perimeter of the hybrid bond as described elsewhere herein. Mobile computing platform 2305 may be any portable device configured for each of electronic data display, electronic data processing, wireless electronic data transmission, or the like. For example, mobile computing platform 2305 may be any of a tablet, a smart phone, a laptop computer, etc., and may include a display screen (e.g., a capacitive, inductive, resistive, or optical touchscreen), a chip-level or package-level integrated system 2310, and a battery 2315. Although illustrated with respect to mobile computing platform 2305, in other examples, chip-level or package-level integrated system 2310 and a battery 2315 may be implemented in a desktop computing platform, an automotive computing platform, an internet of things platform, or the like. As discussed below, in some examples, the disclosed systems may include a sub-system 2360 such as a system on a chip (SOC) or an integrated system of multiple ICs, which is illustrated with respect to mobile computing platform 2305.

Whether disposed within integrated system 2310 illustrated in expanded view 2320 or as a stand-alone packaged device within data server machine 2306, sub-system 2360 may include memory circuitry and/or processor circuitry 2350 (e.g., RAM, a microprocessor, a multi-core microprocessor, graphics processor, etc.), a power management integrated circuit (PMIC) 2330, a controller 2335, and a radio frequency integrated circuit (RFIC) 2325 (e.g., including a wideband RF transmitter and/or receiver (TX/RX)). As shown, IC dice, such as memory circuitry and/or processor circuitry 2350 may be packaged, assembled, and implemented, such that the package includes a 3D die stack having a hybrid bond with a cross-linked hydrophobic material around an outer perimeter of the hybrid bond as described herein. In some embodiments, RFIC 2325 includes a digital baseband and an analog front end module further comprising a power amplifier on a transmit path and a low noise amplifier on a receive path). Functionally, PMIC 2330 may perform battery power regulation, DC-to-DC conversion, etc., and so has an input coupled to battery 2315, and an output providing a current supply to other functional modules. As further illustrated in FIG. 23, in the exemplary embodiment, RFIC 2325 has an output coupled to an antenna (not shown) to implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. Memory circuitry and/or processor circuitry 2350 may provide memory functionality, high level control, data processing and the like for sub-system 2360. In alternative implementations, each of the SOC modules may be integrated onto separate ICs coupled to a package substrate, interposer, or board.

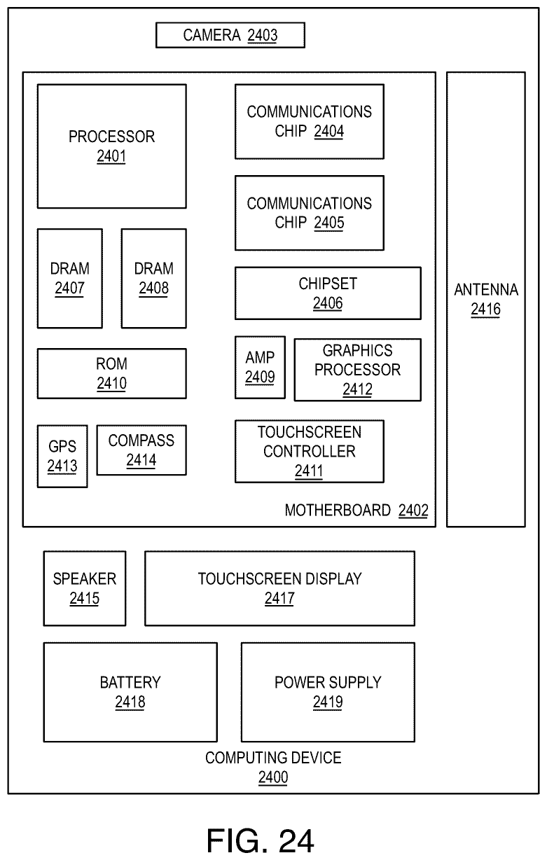

FIG. 24 is a functional block diagram of an electronic computing device 2400, in accordance with some embodiments. For example, device 2400 may, via any suitable component therein, employ a 3D die stack having a hybrid bond with a cross-linked hydrophobic material around an outer perimeter of the hybrid bond in accordance with any embodiments described elsewhere herein. Device 2400 further includes a motherboard package substrate or motherboard 2402 hosting a number of components, such as, but not limited to, a processor 2401 (e.g., an applications processor). Processor 2401 may be physically and/or electrically coupled to package substrate or motherboard 2402. In some examples, processor 2401 is within a packaged IC assembly that includes a 3D die stack having a hybrid bond with a cross-linked hydrophobic material around an outer perimeter of the hybrid bond as described elsewhere herein. In general, the term “processor” or “microprocessor” may refer to any device or portion of a device that processes electronic data from registers and/or memory to transform that electronic data into other electronic data that may be further stored in registers and/or memory.

In various examples, one or more communication chips 2404, 2405 may also be physically and/or electrically coupled to the package substrate or motherboard 2402. In further implementations, communication chips 2404, 2405 may be part of processor 2401. Depending on its applications, computing device 2400 may include other components that may or may not be physically and electrically coupled to package substrate or motherboard 2402. These other components include, but are not limited to, volatile memory (e.g., DRAM 2407, 2408), non-volatile memory (e.g., ROM 2410), flash memory (e.g., NAND or NOR), magnetic memory (MRAM), a graphics processor 2412, a digital signal processor, a crypto processor, a chipset 2406, an antenna 2416, touchscreen display 2417, touchscreen controller 2411, battery 2418, a power supply 2419, audio codec, video codec, power amplifier 2409, global positioning system (GPS) device 2413, compass 2414, accelerometer, gyroscope, speaker 2415, camera 2403, and mass storage device (such as hard disk drive, solid-state drive (SSD), compact disk (CD), digital versatile disk (DVD), and so forth, or the like.

Communication chips 2404, 2405 may enable wireless communications for the transfer of data to and from the computing device 2400. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. Communication chips 2404, 2405 may implement any of a number of wireless standards or protocols, including, but not limited to, those described elsewhere herein. As discussed, computing device 2400 may include a plurality of communication chips 2404, 2405. For example, a first communication chip may be dedicated to shorter-range wireless communications, such as Wi-Fi and Bluetooth, and a second communication chip may be dedicated to longer-range wireless communications such as GPS, EDGE, GPRS, CDMA, WiMAX, LTE, Ev-DO, and others.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

It will be recognized that the invention is not limited to the embodiments so described, but can be practiced with modification and alteration without departing from the scope of the appended claims. For example, the above embodiments may include specific combinations of features as further provided below.

The following pertain to exemplary embodiments.

In one or more first embodiments, an apparatus comprises a substrate comprising an interconnect layer, an integrated circuit (IC) die coupled to the interconnect layer of the substrate by composite metal structures embedded within an inorganic dielectric material, and one or more structures extending around an outer perimeter of the inorganic dielectric material, wherein the one or more structures comprise a material comprising a plurality of polymer chains cross-linked by a plurality of covalent bonds between the polymer chains.

In one or more second embodiments, further to the first embodiments, the covalent bonds between the polymer chains comprise one of a sulfur to carbon covalent bond, an oxygen to carbon covalent bond, a nitrogen to carbon covalent, an acrylate bond, or a methacrylate bond.

In one or more third embodiments, further to the first or second embodiments, the material comprises at least one of a sulfonium salt, an antimonate salt, a peroxide, a quinone, or platinum.

In one or more fourth embodiments, further to the first through third embodiments, the material comprises at least one of a perfluoropolyether acrylate, a siloxane acrylate, a silicone acrylate, a vinyl-terminated silicone, a hydride-terminated silicone, a chain-terminated polyolefin derivative, perfluorodiacrylate, crosslinked polyanline, or hexamethyldisiloxane.

In one or more fifth embodiments, further to the first through fourth embodiments, the polymer chains comprise molecules having a head structure and a tail structure, the head structure comprising one of a silane, a thiol, a hydroxyl, an amino group, a polyoxyethyline group, an alkanoic acid, or a phosphonic acid, and the tail structure comprising one of an aliphatic chain, a fluorinated chain, or perfluoropolyether acrylate.

In one or more sixth embodiments, further to the first through fifth embodiments, the apparatus further comprises a second substrate over the IC die, wherein the second substrate comprises a monolithic material.

In one or more seventh embodiments, further to the first through sixth embodiments, the apparatus or a system including the apparatus comprises a power supply coupled to the substrate or the IC die.

In one or more eighth embodiments, an apparatus comprises a substrate comprising an interconnect layer, an integrated circuit (IC) die coupled to the interconnect layer of the substrate by a hybrid bond therebetween, and one or more hydrophobic materials extending around the hybrid bond, the one or more hydrophobic materials comprising a network polymeric structure.

In one or more ninth embodiments, further to the eighth embodiments, the network polymeric structure comprises covalent bonds between polymer chains of the hydrophobic materials, the covalent bonds comprising one of a sulfur to carbon covalent bond, an oxygen to carbon covalent bond, a nitrogen to carbon covalent bond, an acrylate bond, or a methacrylate bond.

In one or more tenth embodiments, further to the eighth or ninth embodiments, the hydrophobic materials comprise at least one of a sulfonium salt, an antimonate salt, a peroxide, a quinone, or platinum catalyst.

In one or more eleventh embodiments, further to the eighth through tenth embodiments, the network polymeric structure comprises at least one of a perfluoropolyether acrylate, a siloxane acrylate, a silicone acrylate, a vinyl-terminated silicone, a hydride-terminated silicone, a chain-terminated polyolefin derivative, perfluorodiacrylate, or hexamethyldisiloxane.

In one or more twelfth embodiments, further to the eighth through eleventh embodiments, the network polymeric structure comprises molecules having a head structure and a tail structure, the head structure comprising one of a silane, a thiol, an alkanoic acid, or a phosphonic acid, and the tail structure comprising one of an aliphatic chain or a fluorinated chain.

In one or more thirteenth embodiments, further to the eighth through twelfth embodiments, the apparatus further comprises a second substrate over the IC die, wherein the second substrate comprises a monolithic material.

In one or more fourteenth embodiments, further to the eighth through thirteenth embodiments, the apparatus or a system including the apparatus comprises a power supply coupled to the substrate or the IC die.

In one or more fifteenth embodiments, a method comprises forming one or more structures around an outer perimeter of a first hybrid bonding region, wherein the one or more structures comprise a material comprising a plurality of polymer chains cross-linked by a plurality of covalent bonds between the polymer chains, performing a plasma activation of the first hybrid bonding region in presence of the one or more structures, and evaporating a first liquid droplet between the first hybrid bonding region and a second hybrid bonding region, the first hybrid bonding region of a substrate or an integrated circuit (IC) die and the second hybrid bonding region of the other of the substrate or the IC die, to bond the first hybrid bonding region and the second hybrid bonding regions.

In one or more sixteenth embodiments, further to the fifteenth embodiments, forming the one or more structures comprises forming a first layer over the first hybrid boding region and a region of the substrate or the IC die, selectively curing the first layer to form the one or more structures and an uncured portion of the first layer, and removing the uncured portion of the first layer.

In one or more seventeenth embodiments, further to the fifteenth or sixteenth embodiments, said selectively curing the first layer comprises a UV exposure.

In one or more eighteenth embodiments, further to the fifteenth through seventeenth embodiments, forming the one or more structures comprises forming a first layer over the first hybrid boding region and a region of the substrate or the IC die, selectively exposing the first layer over the first hybrid boding region, thermally curing the first layer to form the one or more structures and a non-cross-linked portion of the first layer over the hybrid boding region, and removing the non-cross-linked portion of the first layer.

In one or more nineteenth embodiments, further to the fifteenth through eighteenth embodiments, forming the one or more structures comprises forming a self-assembled monolayer (SAM) over the first hybrid boding region and a region of the substrate or the IC die, cross-linking the SAM to form the one or more structures, and removing the SAM from over the first hybrid boding region.

In one or more twentieth embodiments, further to the fifteenth through nineteenth embodiments, removing the SAM from over the first hybrid boding region comprises forming the SAM over a mask layer on the first hybrid boding region, and lifting off the mask layer and the SAM from over the first hybrid boding region.

It will be recognized that the invention is not limited to the embodiments so described, but can be practiced with modification and alteration without departing from the scope of the appended claims. For example, the above embodiments may include specific combination of features. However, the above embodiments are not limited in this regard and, in various implementations, the above embodiments may include undertaking only a subset of such features, undertaking a different order of such features, undertaking a different combination of such features, and/or undertaking additional features than those features explicitly listed. The scope of the invention should, therefore, be determined with reference to the appended claims, along with the full scope of equivalents to which such claims are entitled.

What is claimed is:

1. An apparatus, comprising:
a substrate comprising an interconnect layer;
an integrated circuit (IC) die coupled to the interconnect layer of the substrate by composite metal structures embedded within an inorganic dielectric material; and
one or more structures extending around an outer perimeter of the inorganic dielectric material, wherein the one or more structures comprise a material comprising a plurality of polymer chains cross-linked by a plurality of covalent bonds between the polymer chains.

2. The apparatus of claim 1, wherein the covalent bonds between the polymer chains comprise one of a sulfur to carbon covalent bond, an oxygen to carbon covalent bond, a nitrogen to carbon covalent, an acrylate bond, or a methacrylate bond.

3. The apparatus of claim 1, wherein the material comprises at least one of a sulfonium salt, an antimonate salt, a peroxide, a quinone, or platinum.

4. The apparatus of claim 1, wherein the material comprises at least one of a perfluoropolyether acrylate, a siloxane acrylate, a silicone acrylate, a vinyl-terminated silicone, a hydride-terminated silicone, a chain-terminated polyolefin derivative, perfluorodiacrylate, crosslinked polyanline, or hexamethyldisiloxane.

5. The apparatus of claim 1, wherein the polymer chains comprise molecules having a head structure and a tail structure, the head structure comprising one of a silane, a thiol, a hydroxyl, an amino group, a polyoxyethyline group, an alkanoic acid, or a phosphonic acid, and the tail structure comprising one of an aliphatic chain, a fluorinated chain, or perfluoropolyether acrylate.

6. The apparatus of claim 1, further comprising:
a second substrate over the IC die, wherein the second substrate comprises a monolithic material.

7. The apparatus of claim 1, further comprising a power supply coupled to the substrate or the IC die.

8. An apparatus, comprising:
a substrate comprising an interconnect layer;
an integrated circuit (IC) die coupled to the interconnect layer of the substrate by a hybrid bond therebetween; and
one or more hydrophobic materials extending around the hybrid bond, the one or more hydrophobic materials comprising a network polymeric structure.

9. The apparatus of claim 8, wherein the network polymeric structure comprises covalent bonds between polymer chains of the hydrophobic materials, the covalent bonds comprising one of a sulfur to carbon covalent bond, an oxygen to carbon covalent bond, a nitrogen to carbon covalent bond, an acrylate bond, or a methacrylate bond.

10. The apparatus of claim 8, wherein the hydrophobic materials comprise at least one of a sulfonium salt, an antimonate salt, a peroxide, a quinone, or platinum catalyst.

11. The apparatus of claim 8, wherein the network polymeric structure comprises at least one of a perfluoropolyether acrylate, a siloxane acrylate, a silicone acrylate, a vinyl-terminated silicone, a hydride-terminated silicone, a chain-terminated polyolefin derivative, perfluorodiacrylate, or hexamethyldisiloxane.

12. The apparatus of claim 8, wherein the network polymeric structure comprises molecules having a head structure and a tail structure, the head structure comprising one of a silane, a thiol, an alkanoic acid, or a phosphonic acid, and the tail structure comprising one of an aliphatic chain or a fluorinated chain.

13. The apparatus of claim 8, further comprising:
a second substrate over the IC die, wherein the second substrate comprises a monolithic material.

14. The apparatus of claim 8, further comprising a power supply coupled to the substrate or the IC die.

15. A method, comprising:
forming one or more structures around an outer perimeter of a first hybrid bonding region, wherein the one or more structures comprise a material comprising a plurality of polymer chains cross-linked by a plurality of covalent bonds between the polymer chains;
performing a plasma activation of the first hybrid bonding region in presence of the one or more structures; and
evaporating a first liquid droplet between the first hybrid bonding region and a second hybrid bonding region, the first hybrid bonding region of a substrate or an integrated circuit (IC) die and the second hybrid bonding region of the other of the substrate or the IC die, to bond the first hybrid bonding region and the second hybrid bonding regions.

16. The method of claim 15, wherein forming the one or more structures comprises:
forming a first layer over the first hybrid boding region and a region of the substrate or the IC die;
selectively curing the first layer to form the one or more structures and an uncured portion of the first layer; and
removing the uncured portion of the first layer.

17. The method of claim 16, wherein said selectively curing the first layer comprises a UV exposure.

18. The method of claim 15, wherein forming the one or more structures comprises:
forming a first layer over the first hybrid boding region and a region of the substrate or the IC die;
selectively exposing the first layer over the first hybrid boding region;
thermally curing the first layer to form the one or more structures and a non-cross-linked portion of the first layer over the hybrid boding region; and
removing the non-cross-linked portion of the first layer.

19. The method of claim 15, wherein forming the one or more structures comprises:
forming a self-assembled monolayer (SAM) over the first hybrid boding region and a region of the substrate or the IC die;
cross-linking the SAM to form the one or more structures; and
removing the SAM from over the first hybrid boding region.

20. The method of claim 19, wherein removing the SAM from over the first hybrid boding region comprises:
forming the SAM over a mask layer on the first hybrid boding region; and
lifting off the mask layer and the SAM from over the first hybrid boding region.
